(19) United States
(12) Patent Application Publication
(10) Pub. No.: US 2005/0172775 A1
(43) Pub. Date: Aug. 11, 2005

(54) Punching apparatus

(76) Inventor: Pei-Yuan Lee, Taipei (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 11/049,090

(22) Filed: Feb. 2, 2005

(30) Foreign Application Priority Data
Feb. 10, 2004 (TW) 093103113

(51) Int. Cl. B26F 1/14

(52) U.S. Cl. 83/628; 83/687

(57) ABSTRACT

A punching apparatus includes a base having thereon a plurality of seats for receiving and holding an object to be punched; an eccentric transmission mechanism disposed on the base and performing a uni-directional eccentric rotation; and a cutting tool assembly transmitted by the eccentric transmission mechanism to alternately switch between a working state where a plurality of cutting tools thereof are moved deep into the seats to punch through the object and a standby state where the cutting tools are retracted from the seats to release the object in response to the uni-directional eccentric rotation.

### FIELD OF THE INVENTION

The present invention relates to a punching apparatus and more particularly to a punching apparatus accomplishing a complete cycle of punching action with uni-directional transmission.

### BACKGROUND OF THE INVENTION

A manual punching apparatus typically utilizes a levering operation to implement the creation of through holes in a punched object. Please refer to FIG. 1 which shows a schematic side elevational view of a conventional punching apparatus. The user exerts a force Fx on a lever 113 to pivot the lever 113 on a fulcrum 111, thereby moving a cutting tool 112 downwards to penetrate through the object (not shown) placed on a platform 110. By properly arranging the position of the cutting tool 112 relative to the fulcrum 111 and the lever 113, for example having the length “b” of the lever 113 much greater than the distance of the cutting tool 112 from the fulcrum 111, the punching operation can be performed with ease. In spite the above punching operation can be improved to some extent to save laboring, the user's effort to exert a force is stilled required for accomplishing each single operation.

Subsequently, an automatic punching mechanism as schematically shown in FIG. 2 was developed. The automatic punching apparatus 12 utilizes a transmission set to accomplish the levering and punching operation. The transmission set includes a transmission gear 122 integrated with a lever 121 and a driving gear 123 coupled to a motor shaft 126. Through the engagement of the driving gear 123 and the transmission gear 122, the lever 121 pivots on the fulcrum 124 to move the cutting tool 125 downwards when the motor shaft 126 rotates clockwise, as indicated by an arrow A, so as to penetrate through the object (not shown) placed on a platform 120. On the other hand, after each punching operation, the rotation of the motor shaft 126 is changed to be counterclockwise, as indicated by an arrow B, so that the cutting tool 125 is raised via the levering operation to release the punched object. Since the motor shaft 126 is reversed whenever a punching operation is completed in order to release the object, it is apparent that such mechanism is subject to significant power loss and the lifespan of the driving motor is adversely reduced. Moreover, the cost associated with two-way transmission means is comparatively high.

Therefore, another automatic punching mechanism accomplishing a complete cycle of punching action with uni-directional transmission was developed, which is disclosed in U.S. Pat. No. 4,987,811 and schematically shown in FIG. 3. The punching apparatus 13 utilizes a rotary disk 131 having thereon a protruding pin 1311 to drive the up and down movement of the lever 132. The protruding pin 1311 is arranged at an eccentric position on the rotary disc 131 and slidably engaging with a slot track 1321 in the lever 132. FIG. 3 shows a moment when the protruding pin 1311 has slid to the rightmost position of the track 1321 and when the cutting tool 133 is in a raised standby state. When the rotary disc 131 continuously turns clockwise to a certain extent, the protruding pin 1311 slides toward the left end of the track 1321 and then lifts the lever 132 up. Meanwhile, the cutting tool 133 is forced down via the fulcrum 134 so as to penetrate through the object (not shown) place on the platform 130. Afterwards, the rotary disc 131 further turns clockwise, and the protruding pin 1311 slides toward the right end of the track 1321 and then pushes the lever 132 down to the position as shown in FIG. 3. Meanwhile, the cutting tool 133 restores to the raised standby state. Since the protruding pin 1311 needs to slide to and fro in the slot track 1321 according to the punching mechanism shown in FIG. 3, frequent friction between the protruding pin 1311 and the lever 132 is rendered. Therefore, abrasion and damage are likely to happen.

### SUMMARY OF THE INVENTION

Therefore, the present invention provides a punching apparatus accomplishing a complete cycle of punching action with unidirectional transmission while eliminating the abrasion problem.

The present invention relates to a punching apparatus, which comprises a base having thereon a first count of seats for receiving and holding an object to be punched; an eccentric transmission mechanism disposed on the base and performing a uni-directional eccentric rotation; and a cutting tool assembly transmitted by the eccentric transmission mechanism to alternately switch between a working state where a second count of cutting tools thereof are moved deep into the seats to punch through the object and a standby state where the cutting tools are retracted from the seats to release the object in response to the uni-directional eccentric rotation.

Preferably, the first count is equal to the second count and further equals to a count of holes to be created in the object, and the seats are fixed on the base at positions corresponding to positions of the cutting tools as well as positions of the holes.

In an embodiment, each of the seats has a room for accommodating a corresponding one of the cutting tools and a groove outside the room for receiving a part of the object, and the corresponding cutting tool is transmitted to extend from the room to the groove to punch through the part of the object and retract into the room to release the object in one cycle of the uni-directional eccentric rotation.

In an embodiment, the eccentric transmission mechanism includes an eccentric rotary wheel and a shaft, and the shaft is driven by a motor to transmit the rotary wheel to do the uni-directional eccentric rotation so that a distant edge of the rotary wheel urges a first sustaining member of the cutting tool mechanism to enter the working state and urges a second sustaining member of the cutting tool mechanism to enter the standby state.

In en embodiment, the cutting tools are coupled to and move with the first sustaining member, and the first sustaining member and the second sustaining member are disposed at opposite sides of the rotary wheel and kept a constant distance therebetween so that the distant edge of the rotary wheel alternately urges against the first sustaining member and the second sustaining member in response to unidirectional eccentric rotation of the rotary wheel.

In an embodiment, the cutting tool assembly comprises a chassis disposed under the eccentric transmission mechanism and slidable relative to the base; a first sustaining member coupled to the cutting tools and fixed on the chassis at a first side of the eccentric transmission mechanism; and a second sustaining member fixed on the chassis at a second side of the eccentric transmission mechanism opposite to the first side. The chassis slides toward the seats and the cutting tools move deep into the seats when the first sustaining member is urged by the eccentric transmission mechanism, and the chassis slides away from the seats and the cutting tools retracts from the seats when the second sustaining member is urged by the eccentric transmission mechanism.

In an embodiment, the eccentric transmission mechanism includes an eccentric rotary wheel and a shaft, and the shaft is driven by a motor to transmit the rotary wheel to do the uni-directional eccentric rotation so that a distant edge of the rotary wheel alternately urges the first sustaining member and the second sustaining member in each cycle of the unidirectional eccentric rotation.

In an embodiment, the first sustaining member comprises an elongated baffle fixed on the chassis or integrally formed with the chassis, and coupled to the cutting tools at one side thereof; and at least one roller coupled to the other side of the baffle and optionally urged by the eccentric transmission mechanism.

In an embodiment, the second sustaining member comprises at least one roller.

In an embodiment, the punching apparatus further comprises a pair of tracks arranged on walls of the base and slidably engaging with the chassis.

In an embodiment, the eccentric transmission mechanism comprises a driving motor disposed on the base and rotating in a uni-direction; a control circuit electrically connected to the driving motor for optionally actuating or suspending the driving motor; and at least one eccentric rotary wheel driven by the driving motor to do the uni-directional eccentric rotation so that a distant edge of the rotary wheel alternately urges a first sustaining member of the cutting tool mechanism to move the cutting tools deep into the seats and urges a second sustaining member of the cutting tool mechanism to retract the cutting tools from the seats.

In an embodiment, the control circuit comprises a sensor disposed on the base for detecting the state of the cutting tool assembly, and the control circuit suspends the driving motor when the cutting tool assembly is switching from the standby state to the working state.

In an embodiment, the sensor is a photo-sensor in which a resistance change occurs in response to an optical signal interrupted by the cutting tool assembly, and the control circuit determines whether the cutting tool assembly is switching from the standby state to the working state according to the resistance change.

Alternatively, the sensor is a micro-switch in which a conduction-state change occurs in response to a trigger action of the cutting tool assembly, and the control circuit determines whether the cutting tool assembly is switching from the standby state to the working state according to the conduction-state change.

In an embodiment, the trigger action of the cutting tool assembly is that the cutting tool assembly contacts a push button of the micro-switch.

In an embodiment, the punching apparatus further comprises a switch electrically connected to the control circuit and optionally triggered for actuating the driving motor.

In an embodiment, the control circuit further comprises a timer for periodically actuating or suspending the driving motor.

### BRIEF DESCRIPTION OF THE DRAWINGS

The present invention may best be understood through the following description with reference to the accompanying drawings, in which:

FIG. 1 is a schematic side elevational view of the punching mechanism of a conventional punching apparatus;

FIG. 2 is a schematic side elevational view of the punching mechanism of another conventional punching apparatus;

FIG. 3 is a partially corss-sectional view of the punching mechanism of a further conventional punching apparatus;

FIG. 4 is a schematic perspective view of a punching apparatus according to an embodiment of the present invention;

FIGS. 5A˜5E are schematic cross-sectional views of the punching apparatus of FIG. 4, which show how the cutting tool assembly is transmitted by the eccentric transmission mechanism;

FIGS. 5F˜5J are schematic cross-sectional views of another embodiment of the punching apparatus according to the present invention, which show how the cutting tool assembly is transmitted by a cam-type eccentric transmission mechanism;

FIG. 6 is a schematic perspective view of a punching apparatus according to another embodiment of the present invention;

FIGS. 7A and 7B are functional block diagrams schematically showing circuitry for positioning the cutting tool assembly in a standby state; and

FIG. 7C is a functional block diagram schematically showing circuitry for controlling the cycle of each punching operation.

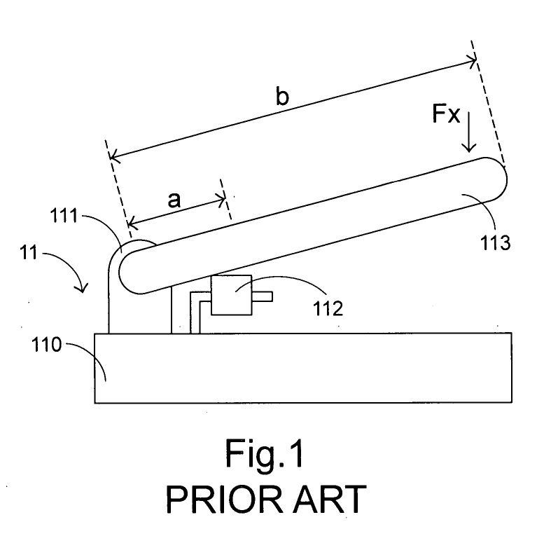

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

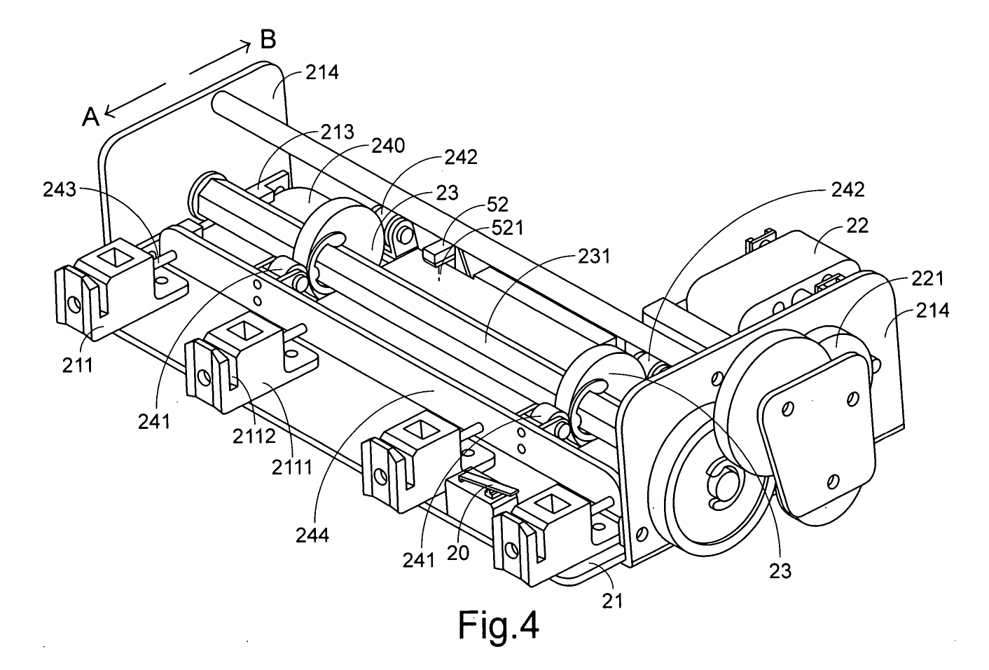

Please refer to FIG. 4 which schematically shows an embodiment of a punching apparatus according to the present invention. In the punching apparatus comprises an eccentric transmission mechanism and a cutting tool assembly are disposed on a base 21 for performing punching action with unidirectional transmission. The eccentric transmission mechanism comprises a driving motor 22, one or more optional gears 221, eccentric rotary wheels 23 and a shaft 231. The shaft 231 penetrates through the rotary wheels 23 and walls 214 of the base 21 and is rotatable with the actuation of the driving motor 22 via the transmission of the gears 221. The cutting tool assembly comprises a chassis 240, rollers 241 and 242, a plurality of cutting tools 243 and an elongated baffle 244. The chassis 240 is disposed under the eccentric transmission mechanism, and the rollers 242 and baffle 244 are fixed on the chassis 240. Alternatively, the baffle 244 can be integrally formed with the chassis 240 to form an L-shaped chassis. The rollers 241 are fixed on one side of the baffle 244, and on the other side of the baffle 244, the cutting tools 243 are arranged. The rollers 241 and 243 are arranged at opposite sides of the rotary wheels 23 and optionally in contact with the circumferential surface of the rotary wheels 23. Alternatively, the rollers 241 and 243 can be replaced by posts, springs or any other suitable members as long as the baffle 244 and the chassis 240 can be well sustained and transmitted.

The punching apparatus further comprises a plurality of seats 211 secured on the base 21 for holding the object to be punched, e.g. paper (not shown), and sliding tracks 213 arranged on the opposite walls 214 of the base 21 for slidably engaging the chassis 240 of the cutting tool assembly with the base 21. The counts of the seats 211 and cutting tools 243 are identical and equal to the count of the holes to be created on the punched object. For example, for punching through the object with four holes, four cutting tools 243 and four seats 211 are provided. Each of the seats 211 has a room 2111 for accommodating a corresponding one of the cutting tools 243 and a groove 2112 outside the room 2111 for receiving a part of the object.

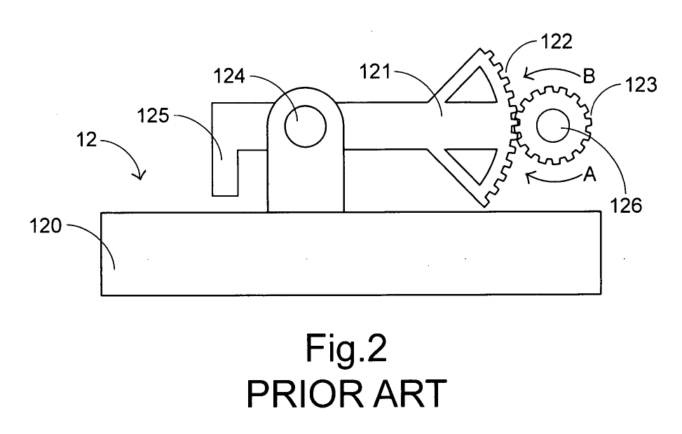

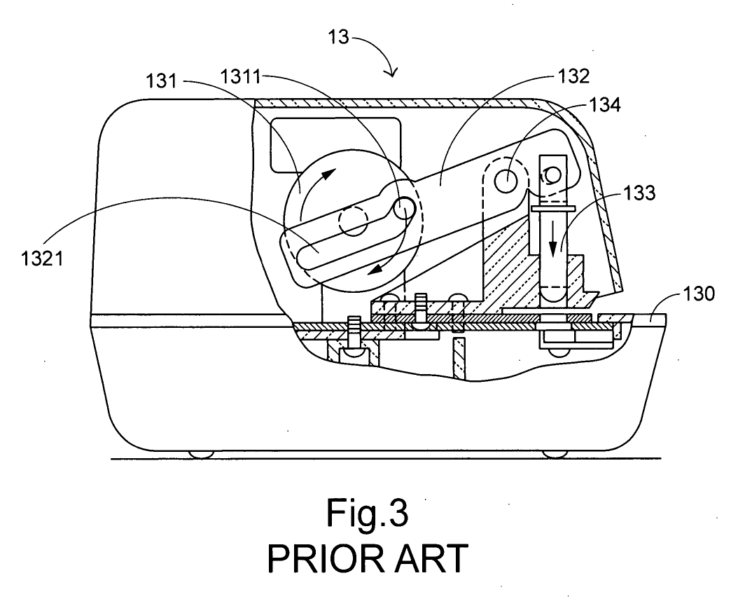

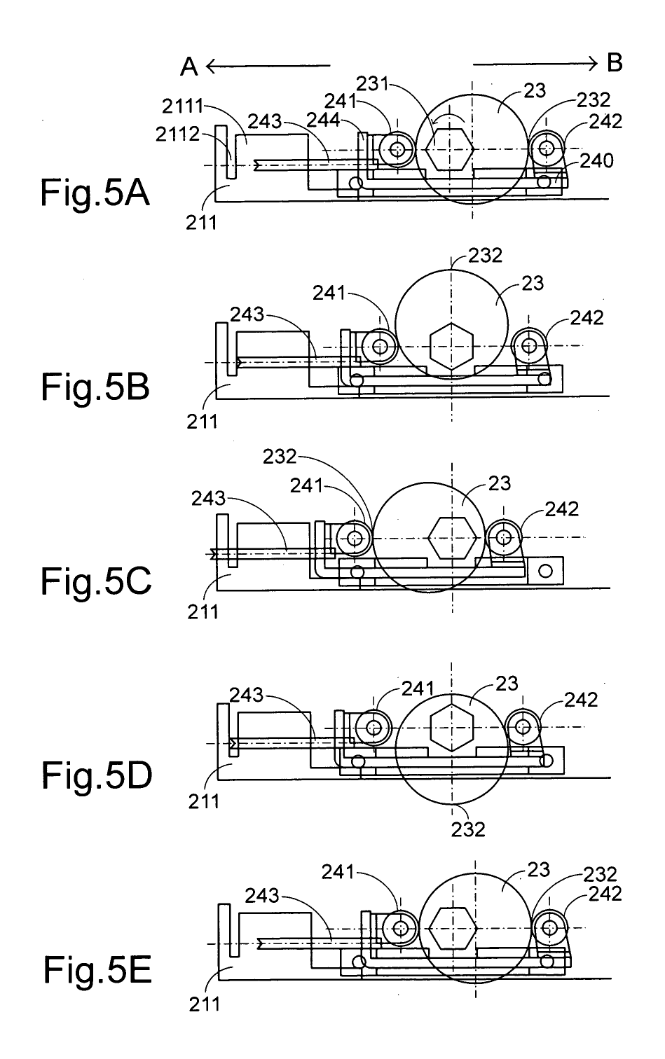

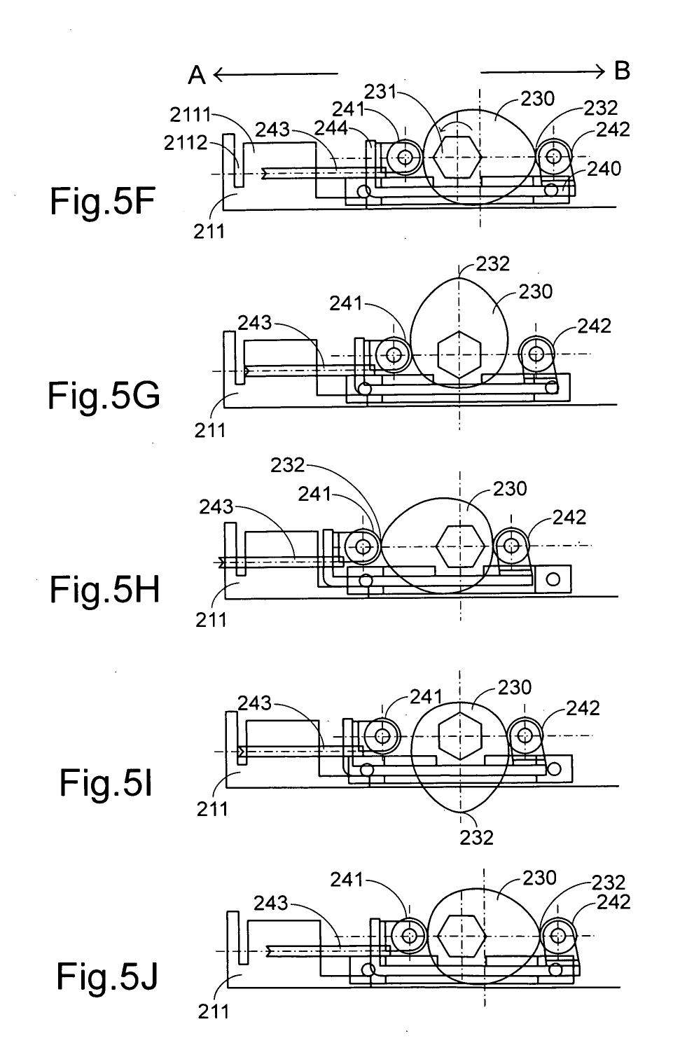

When a punching operation is started by triggering a switch 20, the driving motor 22 rotates the shaft 231 via the gears 221. The rotation of the shaft 231 transmits the eccentric rotary wheels 23 to rotate in a manner as shown in FIGS. 5A˜5E. FIG. 5A shows a standby state of the cutting tool assembly, where a distant edge 232 of the rotary wheel 23 urges against the rollers 242. When the shaft 231 rotates counterclockwise, the distant edge 232 rotates counterclockwise as well and reaches the top position shown in FIG. 5B. Meanwhile, the rollers 241 are urged by the relatively thick portion of the rotary wheel 23 to move slightly in the direction A. Since the roller 241 is fixed on the baffle 244 which is further fixed on the chassis 240, the movement of the roller 241 transmits the chassis 240 to slide along the tracks 213 (FIG. 2). Consequently, the cutting tool 243 fixed on the baffle 244 is moved deep into the room 2111. When the shaft 231 and thus the rotary wheel 23 further rotates counterclockwise, the cutting tool assembly enters a working state and the configuration is as shown in FIG. 5C. The distant edge 232 of the rotary wheel 23 becomes urging against the roller 241, and the cutting tool 243 is pushed to penetrate through the room 2111 and extend into the groove 2112 to pierce the object held therein. Afterwards, further counterclockwise rotation of the rotary wheel 23 results in configurations of FIG. 5D and FIG. 5E, where the rotary wheel 23 gradually pushes the roller 242 to move in a backward direction B. Meanwhile, the chassis 240 where the roller 242 is secured and the cutting tool 243 secured on the chassis 240 via the baffle 244 also move backwards, thereby releasing the punched object. Consequently, the cutting tool 243 retracts from the groove 2112 into the room 2111 to enter the standby state again.

In the above embodiment, an eccentric rotary wheel 23 is used to achieving the purpose of eccentric transmission. Alternatively, the eccentric rotary wheel 23 can be replaced with an eccentric cam 230 to achieve the similar purpose.

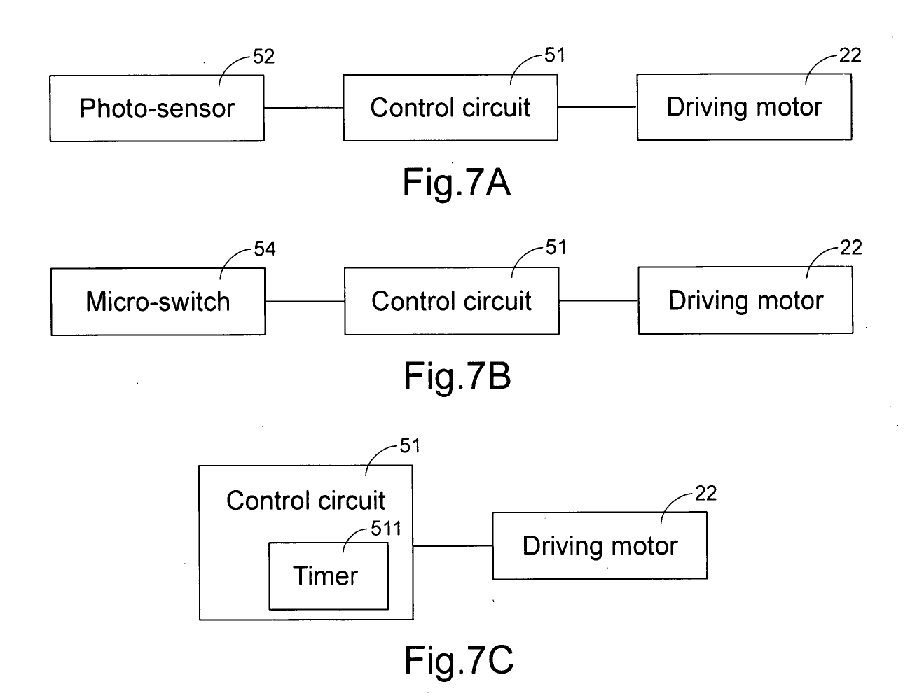

According to the present invention, it is preferred that the punching apparatus is further incorporated therein a positioning mechanism so that the cutting tool assembly can be precisely positioned at an initial position. For achieving this purpose, a sensor 52 and a control circuit 51 electrically connected to the sensor 52 and the driving motor 22 are additionally provided, as illustrated in the block diagram of FIG. 7A. The sensor 52 can be a photo-sensor arranged at a position capable of coupling to the cutting tool assembly, e.g. the chassis 240, when the cutting tool assembly returns the initial position, as shown in FIG. 4. Once the chassis 240 moves back to the initial position so as to interrupt the optical signal 521 to be received by the photo-sensor 52, the resistance inside the photo-sensor 52 changes. When the control circuit 51 detects a resistance change to a certain extent, it is determined the cutting tool assembly has returned its initial position and is switching from the standby state to the working state. Thus the control circuit 51 will suspend the rotation of the driving motor 22. Afterwards, if an additional punching operation is to be performed, the user can trigger the switch 20 (FIG. 4) to actuate the driving motor 22 again.

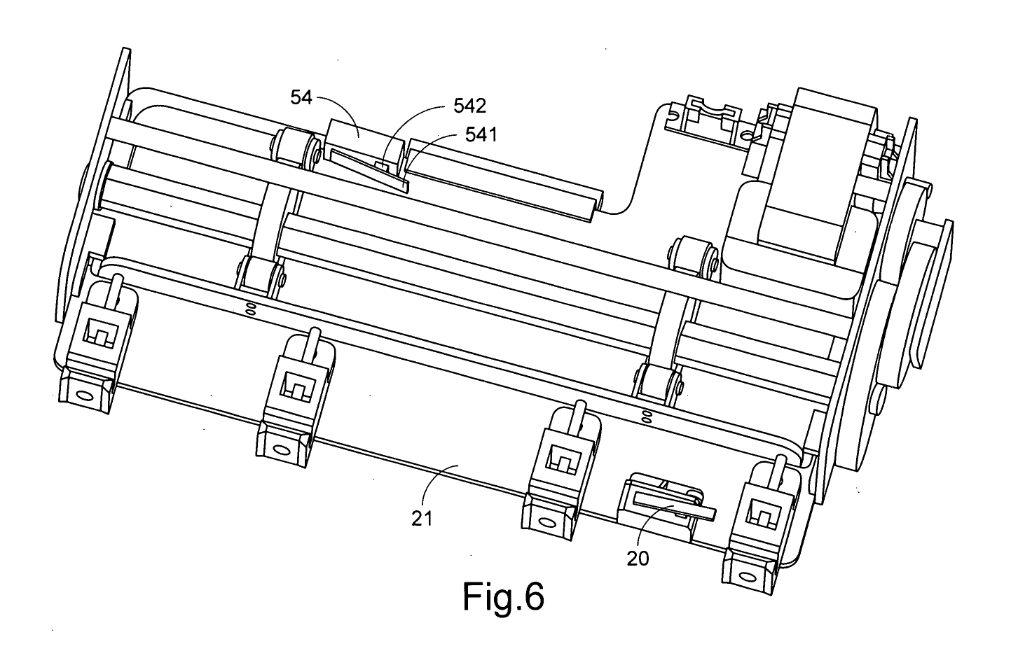

Alternatively, the sensor can be a micro-switch 54 as illustrated in FIG. 6 and FIG. 7B. When the cutting tool assembly returns the initial position and contacts the micro-switch 54 or pushes the lever 541 to trigger a button 542 of the micro-switch 54, the conduction state of the micro-switch 54 changes, for example, from ON to OFF or from OFF to ON. Then, the control circuit 51 determines that the cutting tool assembly has returned its initial position and is switching from the standby state to the working state. Thus the control circuit 51 will suspend the rotation of the driving motor 22. Afterwards, if an additional punching operation is to be performed, the user can trigger the switch 20 to actuate the driving motor 22 again.

In a further embodiment, the sensor 52 or 54 is omitted from the above punching mechanism and a timer 511 is incorporated into the control circuit 51 to control the cycle of each punching operation, as shown in FIG. 7C, so as to periodically actuating or suspending the driving motor.

As illustrated above, and the corresponding cutting tool is transmitted to extend from said room to said groove to punch through the object and retract into the room to release the object in one cycle of uni-directional eccentric rotation. Therefore, the driving motor need not be alternately changed in revolving directions so as to minimize damage of the motor. Further, the self eccentric rotation of the rotary wheel or cam according to the present invention does not result in significant abrasion as the prior art does. Moreover, the elements of the present punching apparatus can be well returned to initial positions so as to avoid dislocation after long-term use.

While the invention has been described in terms of what are presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and structures.

1. A punching apparatus, comprising:
a base having thereon a first count of seats for receiving and holding an object to be punched;
an eccentric transmission mechanism disposed on said base and performing a uni-directional eccentric rotation; and
a cutting tool assembly transmitted by said eccentric transmission mechanism to alternately switch between a working state where a second count of cutting tools thereof are moved deep into said seats to punch through said object and a standby state where said cutting tools are retracted from said seats to release said object in response to said unidirectional eccentric rotation.

2. The punching apparatus according to claim 1 wherein said first count is equal to said second count and further equals to a count of holes to be created in said object, and said seats are fixed on said base at positions corresponding to positions of said cutting tools as well as positions of said holes.

3. The punching apparatus according to claim 2 wherein each of said seats has a room for accommodating a corresponding one of said cutting tools and a groove outside said room for receiving a part of said object, and said corresponding cutting tool is transmitted to extend from said room to said groove to punch through said part of said object and retract into said room to release said object in one cycle of said uni-directional eccentric rotation.

4. The punching apparatus according to claim 1 wherein said eccentric transmission mechanism includes an eccentric rotary wheel and a shaft, and said shaft is driven by a motor to transmit said rotary wheel to do said uni-directional eccentric rotation so that a distant edge of said rotary wheel urges a first sustaining member of said cutting tool mechanism to enter said working state and urges a second sustaining member of said cutting tool mechanism to enter said standby state.

5. The punching apparatus according to claim 4 wherein said cutting tools are coupled to and move with said first sustaining member, and said first sustaining member and said second sustaining member are disposed at opposite sides of said rotary wheel and kept a constant distance therebetween so that said distant edge of said rotary wheel alternately urges against said first sustaining member and said second sustaining member in response to uni-directional eccentric rotation of said rotary wheel.

6. The punching apparatus according to claim 1 wherein said eccentric transmission mechanism includes an eccentric cam and a shaft, and said shaft is driven by a motor to transmit said cam to do said unidirectional eccentric rotation so that a distant edge of said cam urges a first sustaining member of said cutting tool mechanism to enter said working state and urges a second sustaining member of said cutting tool mechanism to enter said standby state.

7. The punching apparatus according to claim 6 wherein said cutting tools are coupled to and move with said first sustaining member, and said first sustaining member and said second sustaining member are disposed at opposite sides of said cam and kept a constant distance therebetween so that said distant edge of said cam alternately urges against said first sustaining member and said second sustaining member in response to unidirectional eccentric rotation of said cam.

8. The punching apparatus according to claim 1 wherein said cutting tool assembly comprises:
a chassis disposed under said eccentric transmission mechanism and slidable relative to said base;
a first sustaining member coupled to said cutting tools and fixed on said chassis at a first side of said eccentric transmission mechanism; and
a second sustaining member fixed on said chassis at a second side of said eccentric transmission mechanism opposite to said first side,
wherein said chassis slides toward said seats and said cutting tools move deep into said seats when said first sustaining member is urged by said eccentric transmission mechanism, and said chassis slides away from said seats and said cutting tools retracts from said seats when said second sustaining member is urged by said eccentric transmission mechanism.

9. The punching apparatus according to claim 8 wherein said eccentric transmission mechanism includes an eccentric rotary wheel and a shaft, and said shaft is driven by a motor to transmit said rotary wheel to do said uni-directional eccentric rotation so that a distant edge of said rotary wheel alternately urges said first sustaining member and said second sustaining member in each cycle of said uni-directional eccentric rotation.

10. The punching apparatus according to claim 8 wherein said first sustaining member comprises:
an elongated baffle fixed on said chassis and coupled to said cutting tools at one side thereof; and
at least one roller coupled to the other side of said baffle and optionally urged by said eccentric transmission mechanism.

11. The punching apparatus according to claim 10 wherein said elongated baffle is integrally formed with said chassis.

12. The punching apparatus according to claim 8 wherein said second sustaining member comprises at least one roller.

13. The punching apparatus according to claim 8 further comprising a pair of tracks arranged on walls of said base and slidably engaging with said chassis.

14. The punching apparatus according to claim 1 wherein said eccentric transmission mechanism comprises:
a driving motor disposed on said base and rotating in a uni-direction;
a control circuit electrically connected to said driving motor for optionally actuating or suspending said driving motor; and
at least one eccentric rotary wheel driven by said driving motor to do said uni-directional eccentric rotation so that a distant edge of said rotary wheel alternately urges a first sustaining member of said cutting tool mechanism to move said cutting tools deep into said seats and urges a second sustaining member of said cutting tool mechanism to retract said cutting tools from said seats.

15. The punching apparatus according to claim 14 wherein said control circuit comprises a sensor disposed on said base for detecting the state of said cutting tool assembly, and said control circuit suspends said driving motor when said cutting tool assembly is switching from said standby state to said working state.

16. The punching apparatus according to claim 15 wherein said sensor is a photo-sensor in which a resistance change occurs in response to an optical signal interrupted by said cutting tool assembly, and said control circuit determines whether said cutting tool assembly is switching from said standby state to said working state according to said resistance change.

17. The punching apparatus according to claim 15 wherein said sensor is a micro-switch in which a conduction-state change occurs in response to a trigger action of said cutting tool assembly, and said control circuit determines whether said cutting tool assembly is switching from said standby state to said working state according to said conduction-state change.

18. The punching apparatus according to claim 16 wherein said trigger action of said cutting tool assembly is that said cutting tool assembly contacts a push button of said micro-switch.

19. The punching apparatus according to claim 14 further comprising a switch electrically connected to said control circuit and optionally triggered for actuating said driving motor.

20. The punching apparatus according to claim 14 wherein said control circuit further comprises a timer for periodically actuating or suspending said driving motor.
